(19) United States
(12) Patent Application Publication
(10) Pub. No.: US 2006/0057348 A1
(43) Pub. Date: Mar. 16, 2006

(54) Oriented composite thermoplastic material with reactive filler

(76) Inventors: Frank W. Maine, Guelph (CA); William R Newson, Toronto (CA)

Correspondence Address: LAW OFFICES OF RONALD M ANDERSON, 600 108TH AVE, NE, SUITE 507, BELLEVUE, WA, 98004, US

(21) Appl. No.: 10/522,071

(22) PCT Filed: Jul. 18, 2003
(86) PCT No.: PCT/CA03/01054

§ 371 Date: Jul. 11, 2005

Related U.S. Application Data
(60) Provisional application No. 60/398,027, filed on Jul. 24, 2002.

(51) Int. Cl. B32B 5/02

(52) U.S. Cl. 428/221

(57) ABSTRACT

A composite material is provided which includes a highly oriented polymer produced by a drawing process and a particulate filler capable of reacting with a fluid to form a cementitious bond. The amount and degree of dispersion of the filler is selected to form interpenetrating polymer and cementitious networks upon reaction of the filler with the fluid.

### FIELD OF THE INVENTION

This invention relates to composite materials in which a particulate filler is dispersed throughout a highly oriented polymer. More particularly, the present invention relates to such composite structures in which the particulate filler is reactive.

### BACKGROUND OF THE INVENTION

The Inventor's earlier patent application PCT/CA00/01555 describes a composite material and a process for making such a composite material. The process comprises the following process steps:
i. Combining an orientable extrudable thermoplastic polymer with a particulate filler to form a starting material;
ii. heating and extruding the starting material into a first column;
iii. adjusting the temperature of the first column to a drawing temperature;
iv. presenting the first column to a drawing die and causing the first column to exit the drawing die as a second column having a cross-sectional area less than that of the first column; and,
v. applying a pulling force to the second column to draw the first column through the drawing die at a rate sufficient to cause orientation of the polymer and to cause the second column to diminish in density to form the composite material.

A surprising result of the above process when practiced, for example with polypropylene and wood sawdust, is that the resulting product is a porous structure with many of its properties comparable to wood and in many applications suitable as a replacement for wood. In many applications the resulting product would be beneficial over wood as the resulting product is relatively moisture impervious and therefore would survive much better than wood in rot-conducive environments.

The present invention considers the use of reactive particulate fillers to achieve further enhanced properties in the end product.

It is an object of the present invention to provide a composite material comprising an oriented polymer and a cementitious particle filler in which the composite material has a density less than the theoretical density of the combined starting materials and in which the oriented polymer forms a matrix throughout which the cementitious particulate filler is dispersed in such a way that the cementitious filler may be reacted with a suitable fluid to create a cementitiously bonded structure interpenetrating the oriented polymer matrix.

### SUMMARY OF THE INVENTION

A composite material is provided which has a highly oriented thermoplastic polymer produced by a drawing process and a particulate filler capable of reacting with a fluid to form a cementitious bond. The amount and degree of dispersion of the filler is such as to form interpenetrating polymer and void networks in the composite material allowing reaction of the filler with the fluid.

The particulate filler may be a silicate cement or gypsum.

In one embodiment of the invention the particulate filler includes at least one of Portland cement and calcium sulphate hemi-hydrate.

The particulate filler may further include a non-reactive component such as wood sawdust.

### DESCRIPTION OF DRAWINGS

Preferred embodiments of the present invention will now be described by way of example only, with reference to the accompanying figures in which:

FIG. 1 is a cross-sectional illustration of a forming method for forming a composite material according to the present invention;

FIG. 2 is a schematic illustration of a continuous process for forming a composite material according to the present invention;

FIG. 3 is a graph illustrating water uptake over time of a hydrated die drawn composite material according to an embodiment of the present invention;

FIG. 4 is a graph illustrating water loss over time of a hydrated die drawn composite material according to an embodiment of the present invention;

FIG. 5 is a graph illustrating water uptake and loss over time of a hydrated composite material according to an embodiment of the present invention;

FIG. 6 is a graph illustrating the rate at which the mass of hydrated and unhydrated samples of a composite material according to an embodiment of the present invention changes as the samples are burned;

FIG. 7 is a graph illustrating the correspondence of flame height to burn rate of the sample of FIG. 6;

FIG. 8 is a graph illustrating the relative load carrying capacities of hydrated and unhydrated composite materials having a first percentage filler according to an embodiment of the present invention;

FIG. 9 is a graph illustrating the relative load carrying capacities of hydrated and unhydrated composite materials having a second percentage filler according to an embodiment of the present invention;

FIG. 10 is a graph illustrating the relative load carrying capacities of hydrated and unhydrated composite materials having a third percentage filler according to an embodiment of the present invention; and,

FIG. 11 is a graph illustrating water loss of a hydrated free drawn composite material according to an embodiment of the present invention.

### DESCRIPTION OF PREFERRED EMBODIMENTS

A drawing process for producing a highly oriented thermoplastic polymer with a particulate filler suitable for the present application has been described in PCT Application No. PCT/CA00/01555 and is described in the background above.

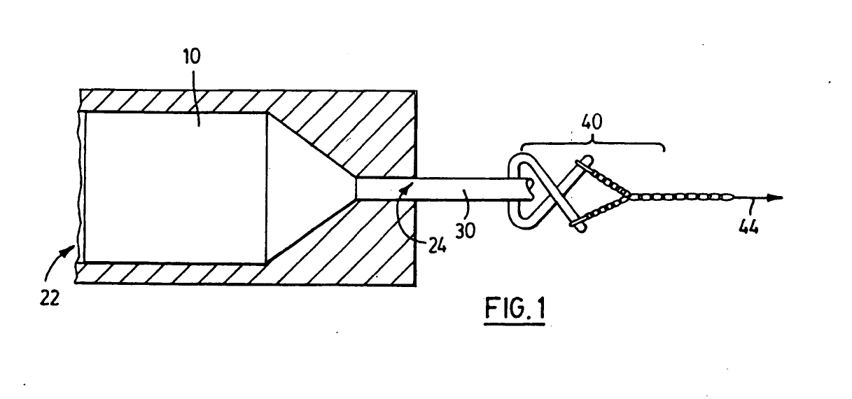

FIG. 1 illustrates the drawing process. According to FIG. 1 a blended feed material which is an orientable thermoplastic polymer and a filler material generally indicated by reference 10 is forced through an extruding die 20 having a passage 22 which diminishes in cross-sectional area toward an outlet 24. The blended material is heated and initially forced through the outlet 24 until an end 30 appears which may be grasped by a pulling apparatus 40. A pulling force sufficient to cause both orientation and a diminishment in density is applied in the direction of arrow 44 and the end result is a porous highly oriented polymer matrix dispersed throughout which is the particulate filler material and air.

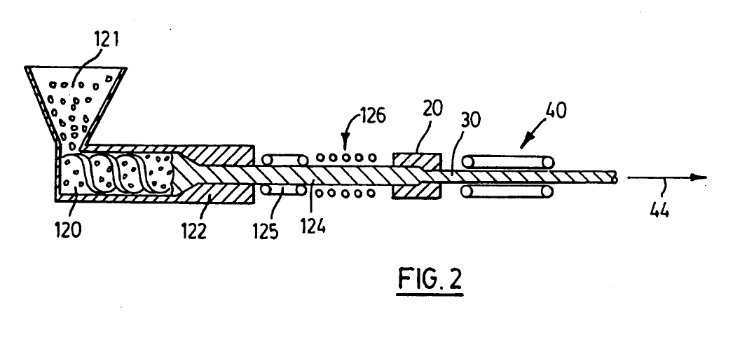

FIG. 2 illustrates a continuous process for use with an apparatus such as the die 20 illustrated in FIG. 1 with the principal difference being that gripping belts such as illustrated at reference 40 are utilized instead of a chain and clamp arrangement as illustrated in FIG. 1. Upstream (to the left as illustrated) of the die 20 is a feed hopper 121 which feeds an extruder 120 which co-mingles and melts a combination of an orientable polymer and particulate filler and further urges the co-mingled mixture through an extrusion die 122. A first haul-off 125 feeds the extruded column through a continuous furnace 126 where the column temperature is adjusted to a drawing temperature. The balance of the process is substantially the same as illustrated in FIG. 1.

As mentioned above, the initial work was done utilizing relatively inert fillers by which it is meant that the filler was generally non-reactive both with the polymer and in typical application environments.

According to the present invention, reactive particulate fillers are contemplated which may for example provide interpenetrating network systems permeating through the oriented polymer matrix and/or anti-microbial properties. There may be other applications for the present technology with various reactive fillers. By way of example, some calcium compounds have been contemplated as potential candidates. Properties of some of these are described below however it should be appreciated that these are merely examples and not an exhaustive list.

There are many fillers used in thermoplastics and the initial consideration has been given to ones that may have the highest potential economic impact. Portland cement and Calcium sulphates (or gypsum) are considered because of their reactability with water and the possibility of forming the filled oriented polymer first and reacting it with water as a secondary operation. This is unique in the history of forming cement and gypsum products.

Table 1 gives a brief overview of these families of fillers.

TABLE 1
Calcium compounds in this study
Calcium Silicate (Portland Cement)

| | | | Cost(US | Common |
|---|---|---|---|---|
| Material | Formula | Density | $/tonne) | Name |
| Calcium | CaO.SiO₂ | 3 | 150-180 | Portland |
| Silicate | | | | Cement |
| Calcium | CaSO₄.1/2H₂O | 2.32 | 150-180 | Gypsum |
| Sulphate | | | | |

Portland cement is made from limestone, clay and sand as the primary ingredients in a rotating furnace called a rotary kiln where temperatures reach 1500° C. (2,732° F.). The intense heat causes chemical reactions that convert the partially molten raw materials into pellets called clinker. After adding some gypsum and other key materials, the mixture is ground to an extremely fine grey powder (75 micron) called “Portland cement”. There are different types of Portland cement that are manufactured to meet various physical and chemical requirements. The American Society for Testing and Materials (ASTM) Specification C-150 provides for eight types of Portland cement. For example, Type 1 Portland cement is a normal, general-purpose cement suitable for all uses and is the type that will be used in this work.

The four major compounds in Portland cement have compositions approximating to tricalcium silicate C3S, dicalcium silicate C2S, tricalcium aluminate C3A and tetracalcium aluminoferrite C4AF. Small variations in the lime content cause large alterations in the C3S and C2S contents of cements. The presence of an excess of uncombined or free lime must be avoided in cement clinker, since it undergoes an increase in volume during hydration, so weakening the hardened paste.

The anhydrous cement compounds, when mixed with water to form pastes, produce unstable saturated lime solutions from which the hydration products are gradually deposited by an exothermic reaction. When they are hydrated separately, the four major compounds produce their own reaction products and gain strength at different rates. Tricalcium silicate C3S has all the attributes of Portland cement. When finely ground and mixed with water, it hydrates quickly and crystals of calcium hydroxide Ca(OH)₂ are rapidly precipitated. Around the original grains, a gelatinous hydrated calcium silicate is formed which, being impermeable, slows down further hydration considerably. Hydrated C3S sets or stiffens within a few hours and gains strength very rapidly, attaining the greater part of its strength within one month. Beta dicalcium silicate bC2S, the hydraulic form of C2S, exhibits no definite setting time, but does stiffen slowly over a period of some days. It produces little strength for about fourteen days, but after one year its strength is equal to that of C3S. The greater reactivity of C3S can be attributed to the more open structure of the crystal lattice of C3S compared with the denser packing of the ions in bC2S. Tricalcium aluminate C3A reacts very rapidly with water and the paste sets almost instantly with the evolution of so much heat that it may dry out. The addition of 3-4% gypsum to cement clinker, which corresponds to 25-50% of the C3A content, produces a normal setting time. Hydrated C3A produces little strength and has a low resistance to sulphate attack. Tetracalcium aluminoferrite C4AF, or the ferrite phase, reacts quickly with water, but less rapidly than C3A, and develops little strength.

When the four major compounds are mixed together in Portland cement, the presence of gypsum appears to have little effect on the rates of hydration and reaction products of the two calcium silicate compounds C3S and bC2S, whereas it affects C3A and C4AF considerably. In the presence of a lime and gypsum solution, C3A produces not only a calcium aluminate hydrate, but also calcium sulphoaluminate compounds. In the case of C4AF, an analogous sulphoferrite is formed but both of these sulphate compounds have little or no cementitious value.

Manufacturers of Portland cement in Canada are:

Ciment Quebec Inc.

Essroc Italcementi Group www.essroc.com

Federal White Cement Ltd.

Glacier Northwest Canadian Ltd. www.glaciernw.com

Lafarge North America Inc.

Lehigh Inland Cement Limited

Miller Cement www.millergroup.ca

St. Lawrence Cement Inc. www.stlawrencecement.com

St. Mary's Cement Company

Calcium Sulphate (Gypsum)

Gypsum is hydrated calcium sulphate, CaSo4.2(H2O). It is one of the more common minerals in sedimentary environments. It has a hardness of 2 and a specific gravity (now called relative gravity) of 2.3+. Natural gypsum rock is mined from the ground and then crushed, milled into a fine powder. It is then calcined where ¾ of the chemically-bound water is removed. The result is stucco also commonly known as plaster of Paris, a very dry powder that, when mixed with water, quickly rehydrates and “sets up”, or hardens.

Manufacturers of Gypsum in North America are:

National Gypsum Company www.national-gypsum.com

G-P Gypsum www.gp.com/gyspum

James Hardie Gypsum www.hardirock.com

CGC Inc. www.cgcinc.com

USG www.usg.com

American Gypsum www.americangypsum.com

### Embodiments

Fibre reinforced cements utilizing asbestos or cellulose fibres have been used widely for siding applications in the home building industry. Disadvantages to the current cement siding/cement shingle configurations include significant weight for shipping purposes and a rather fragile structure which must be delicately handled.

In contrast, according to the present invention, a structure is provided in which a particulate filler material capable of forming a cementitious bond is dispersed throughout a highly oriented polymer but unreacted with the fluid or catalyst which would cause it to set. This yields a product with a relative light weight and toughness compared to fiber cement that is light to ship, robust and easy to install. Subsequent to its installation, it can be hydrated either naturally through ambient humidity or by being doused with water, to form a cementitious bond between adjacent pockets of cementitious material to yield interpenetrating polymer and cement matrices. Hydration may also occur prior to shipping.

Although the particulate filler material may be entirely cementitious material, it may also be a cementitious material blended with a filler, for example wood sawdust or some other non-reactive (in the environment) filler.

In order to achieve interconnectivity between the “pockets” of particulate filler material, the proportion of filler to polymer must be sufficient to ensure that the pores of the porous oriented polymer matrix are substantially open and the particulate filler occupies a relatively large portion of the pores or voids in the polymer matrix. This contrasts with the invention described in Inventor's earlier patent application PCT/CA00/01555, wherein the composite material was made up of a porous oriented polymer matrix filled with substantially closed pores containing air and the particulate filler material. A substantial portion of the volume was air and the particulate filler occupied a relatively small portion of the pores or voids in the polymer matrix.

In the present invention, if the proportion of filler is too small, it will remain in closed pores thereby being inaccessible to the reacting fluid which causes the cementitious reaction. The specific proportions of filler to polymer may depend to some extent on the process parameters such as draw rate and temperature. In general however it is expected that about a 50:50 volume ratio will be required to establish interpenetrating networks. It should be appreciated that the volume ratio may be significantly different than the weight ratio of the constituent components, depending on the density of the components. For example, Portland cement has a relative gravity of 3.1 whereas polypropylene has a relative gravity of 0.9.

In a preferred embodiment of the invention, the orientable thermoplastic polymer is polypropylene. However, a person skilled in the art will recognize that other orientable thermoplastic polymers, such as polyethylene, polystyrene, polyvinyl chloride (“PVC”) and PET may be employed. The foregoing list is by way of example only and is not intended to be exhaustive, any thermoplastic polymer that yields an increase in its force versus elongation properties as a result of being drawn at an elevated temperature, likely arising from a “stretching-out” of its constituent molecular makeup, may be used.

In Situ Hydrated Die Drawn Expanded Oriented Cement Polypropylene:

Common Portland cement was compounded by Aclo compounders with virgin polypropylene copolymer (Basell PDC 1275, MFI 8-10) at a rate of 75 wt % cement to 25 wt % polypropylene. This compound was further mixed with virgin homopolymer polypropylene (BP 10-6014, MFJ approx 0.7) to produce final materials having various levels of Portland cement. These cement/polypropylene materials. were extruded on a single screw extruder (1.75″ Deltaplast) through a 1.75″×0.375″ die.

In the initial experiments the materials extruded at a rate of 1 ft/min and were composed of 37.5 wt %, 52.5 wt %, and 67.5 wt % cement in polypropylene. These materials then passed through an 8 ft forced convection oven at 145 degrees Celsius and were then continuously pulled through a heated converging die (145 degrees C.) with top and bottom die angles of 15 degrees and side angles of 25 degrees, and the ratio of part size to outlet area of 1.8.

Each of these cement filler levels resulted in a different density in the final part, as is listed in Table 2 below. Drawing (i.e., die drawing or free drawing) the composite material results in a material having a relative density significantly less that that of its starting billet. As with the case of expanded oriented wood filled polypropylene, it is believed that this reduced density is a result of the particulate filler and the polypropylene not adhering to each other (possibly due to a mismatch in the respective polarities of the particulate filler and the polypropylene), but rather remaining apart and thereby creating voids during the drawing process.

The densities in Table 2 were calculated by measuring the dimensions and mass of the specimens, calculating the volume, and through that the density. Liquid displacement methods for measuring density or volume are not reliable in this case as the material will readily absorb some liquid into the porous structure.

TABLE 2

| Weight % | | |
|---|---|---|
| Portland cement | Weight % polypropylene | Density g/cm³ |
| 37.5 | 62.5 | 0.90 |
| 52.5 | 47.5 | 0.85 |
| 67.5 | 32.5 | 0.82 |

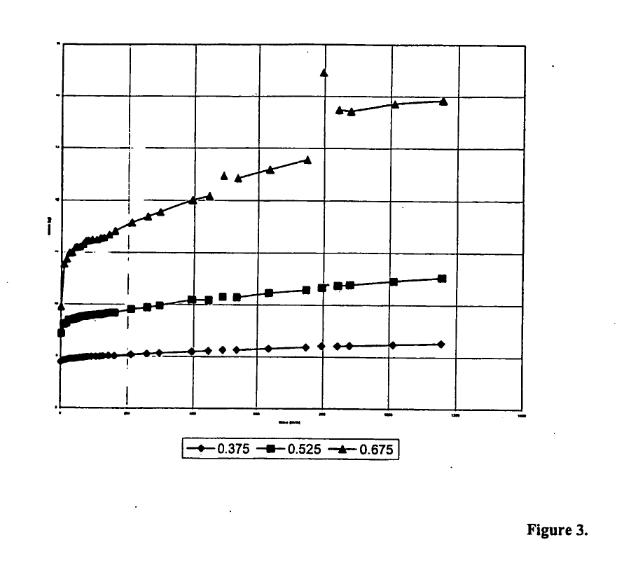

As the amount of cement increases, the overall density decreases as the cement particles act to form voids during the drawing process resulting in a porous final material. This porous final material can be immersed in water in order to hydrate the cement within the voids of the porous structure. In order to accelerate the water uptake the samples were placed in an ordinary kitchen model pressure cooker. At various times the samples were removed from the pressure cooker, their surfaces dried and they were weighed. FIG. 3 illustrates the water uptake over a period of time for the three samples.

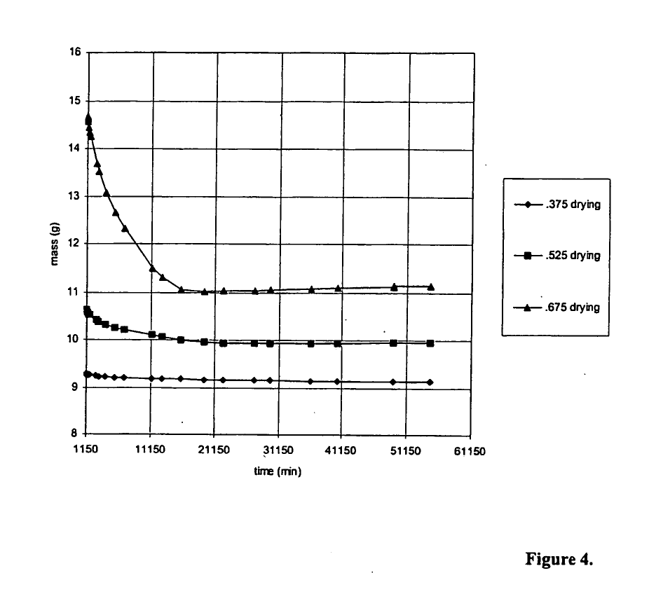

The void fraction was calculated using the density of the material before and after drawing. At the end of the water uptake test just under 90% of the void volume was filled in the 67.5% cement case. It was expected that this water would react with the cement forming a hydrated product inside the voids of the porous material. In order to examine the degree of hydration of the cement, the samples were allowed to cure in air at ambient conditions and their weight tracked (FIG. 4).

Although FIG. 4 reveals that much of the water is lost, some is retained after the sample reaches a steady state (as in the 67.5% cement sample after 16 000 minutes). The mass ratio of retained water to cement indicates the level of hydration. In the case of the 67.5% cement sample the mass ratio of cement to water is 6.3:1.

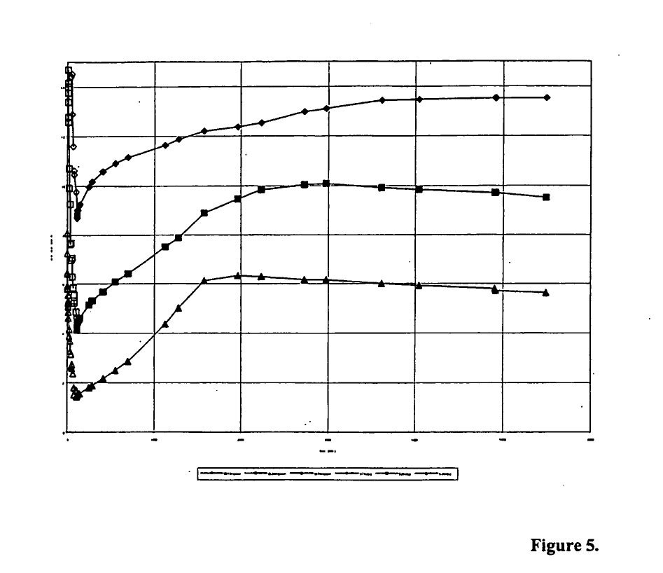

The same test is plotted in FIG. 5, but the ratio of cement to water was calculated. It can be seen at the end of the test that there was retained water. It should be noted that a low cement to water ratio is desired for full hydration.

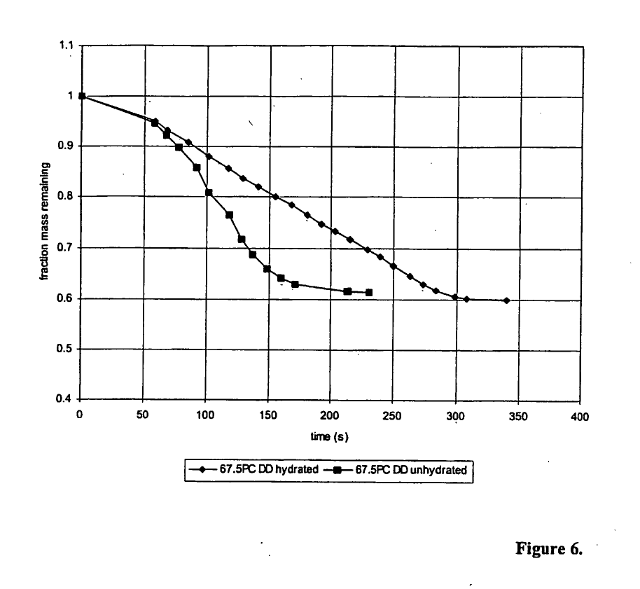

To examine the effect of combustion on the hydrated cement, samples of hydrated and unhydrated 67.5% Portland cement in polypropylene were placed in a wire holder on a foil pan in a scale. These samples were ignited with a butane flame and the combustion of the material recorded, mass change and flame height. As combustion proceeded the mass decreased, the rate of decrease being slower in the hydrated sample compared to the unhydrated sample. FIG. 6 illustrates the rate of mass change of the hydrated and unhydrated samples, the hydrated sample exhibiting a slower rate of mass loss than the unhydrated sample. The mass is presented as fraction of initial sample mass.

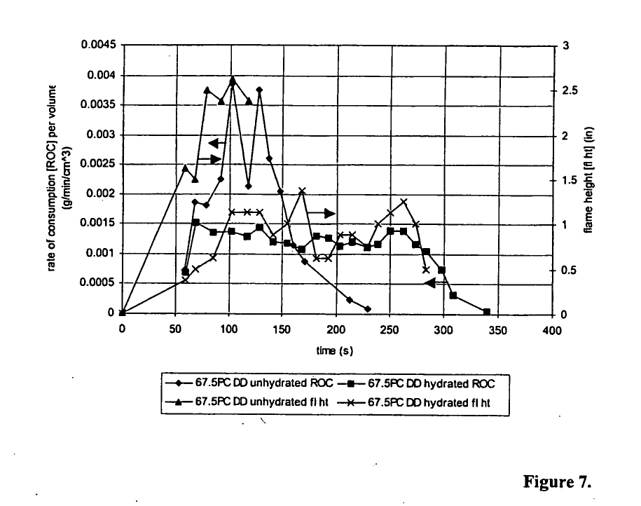

FIG. 7 illustrates the mass and flame height data of the combustion experiment. The results of the rate of material consumption (g/min/cm³) were plotted along with the flame height. The rate of consumption is reflected in the flame height and the hydrated samples exhibited markedly lower flame heights and rates of material consumption. It is noted that the unhydrated sample began dropping large chunks of material at 118 seconds, while the hydrated sample remained intact throughout the test.

As the polypropylene was effectively burned out of the material, it was apparently in a continuous phase and wicked to the surface as it burned/smoked. As the residue was only slightly smaller than the unburned original sample it is apparent that the hydrated cement either fills the voids with a very porous cement, or it coats the outer walls of the void and in this way maintains the volume of the part after combustion stopped. As the remaining hydrated cement remained as a solid block and did not immediately turn to dust it may constitute a second continuous phase, or the domains of hydrated cement may be simply held together mechanically or by ash from the burning polypropylene. In any case, after the polypropylene was consumed the remaining material had so little strength that it would be considered useless as a structural material and would even have turned to dust with a bit of wind. Microscopic examination (at 50× power) did not reveal any change in the appearance of the voids before and after hydration. At present, the exact form of the hydrated cement is unknown.

From these results it can be seen that the cement does reach a certain level of hydration, that this hydrated cement does not stop the polypropylene from burning but does modify that burning process compared to inert fillers. Also, the cement remainder did not immediately crumble after the polypropylene was removed. This indicates that the hydrated cement was not in the form of small particles in the voids, but spread out in the voids (probably with a high pore size) and either formed an attached network of particles or were mechanically locked together due to their shape.

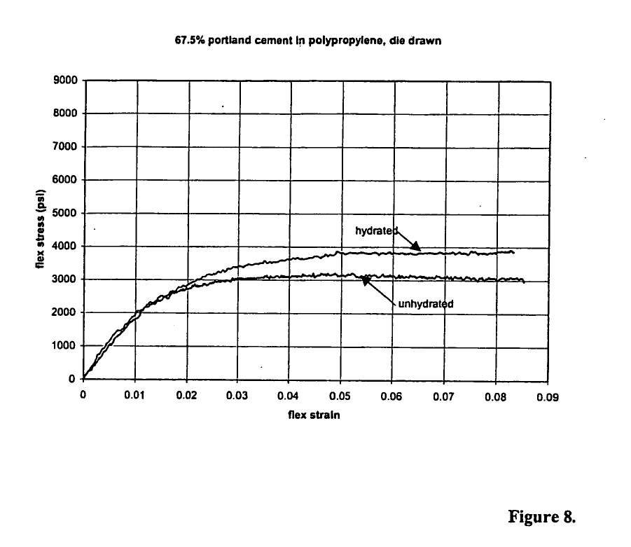

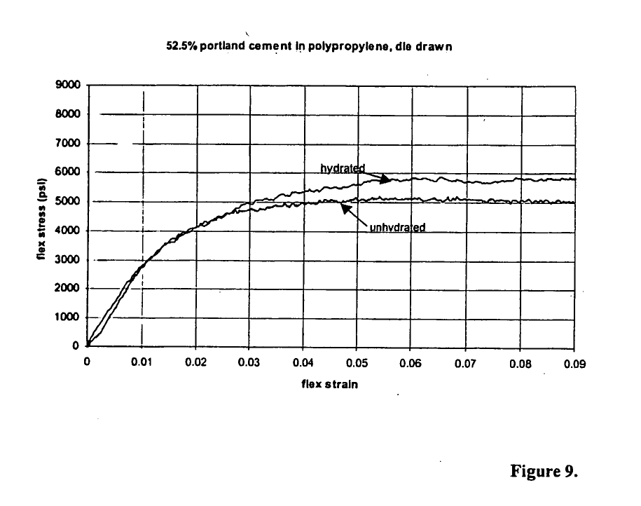

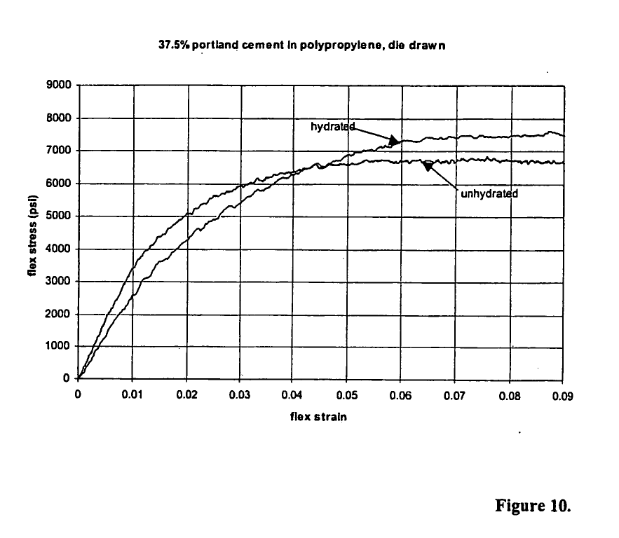

Samples of hydrated and unhydrated die drawn Portland cement-polypropylene were tested in 3 point bending using a test span to thickness ratio of no less than 16:1 (as demonstrated in FIGS. 8 to 10). The results indicate that in all cases the samples that have been exposed to the described hydration process have increased load carrying capacity; FIG. 8 illustrating a comparison of samples having a 67.5% wt cement content, FIG. 9 illustrating a comparison of samples having a 52.5% wt cement content, and FIG. 10 illustrating a comparison of samples having a 37.5% wt cement content.

In Situ Hydrated Free Drawn Expanded Oriented Cement Polypropylene:

Strips of extruded cement/polypropylene with cement contents of 40,50, and 60% (by weight) were prepared and freely drawn (i.e., drawn without using a die) in a batch mode using the draw bench. Samples 48″ in length were cut and drilled for a ⅜″ pin 2″ from one end. These cut samples were placed in a 150 C oven for a minimum of 30 minutes. The samples were then removed from the oven, the tail end cooled in water for a few seconds, and placed through the chamber of the draw bench (150 C) with a pin through the tail end. The other end was then gripped with the gripper of the draw bench and pulled at 8.5 ft/min. The first set of samples was pulled until the neck formed was close to the cooled material around the retaining pin. A second set of runs was performed where the samples were pulled until either the part broke or the rig could pull no further. The density and linear draw ratio (LDR) of the samples can be found in Table 3.

TABLE 3

| | | | Trial 2 - stretched as far | |
|---|---|---|---|---|
| Cement | Trial 1 - stopped early | | as possible | |
| content (wt) | Density g/cm³ | LDR | Density g/cm³ | LDR |
| 40% | .74 | 13 | .59 | 17 (out of |
| | | | | space) |
| 50% | .75 | 11.5 | .62 | 16.5 (out of |
| | | | | space) |
| 60% | .66 | 11.125 | .64 | 12 (broke) |

The samples from trial one were placed in a kitchen model pressure cooker and exposed to steam at the design pressure for the device. The parts were removed at intervals, the surface dried and then weighed. After some time in the pressure cooker the parts were removed and quickly placed in room temperature water so that the surfaces didn't have time to cool and their weight periodically measured. After this they were placed in ambient air temperature to cure.

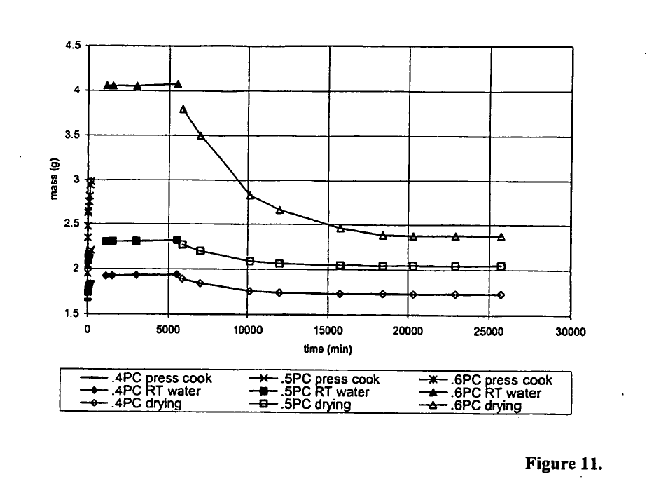

In terms of the cement to water mass ratio these free drawn specimens exhibit a high initial water content due to their large void volume, but after a time the hydrated cement gives off water until it reaches a steady state much like the die drawn cement samples of the previous section. (FIG. 11)

The above is intended as an illustrative rather than a restrictive description of the invention. Variations may be apparent to those skilled in the relevant art without departing from the spirit and scope of the invention as defined by the claims set out below. Although various mechanisms have been suggested, which are presently believed to contribute to the resultant product, they are included simply to assist in understanding the invention. It should be clear that some of these mechanisms are speculative and accordingly should not be considered as limitation to the invention described.

1. A composite structural material comprising:
a highly oriented polymer produced by a drawing process; and,
a particulate filler non-adhering with said highly oriented polymer capable of reacting with a fluid to form a cementitious bond;
said filler being present in an amount, and dispersed to a degree, sufficient to form interpenetrating polymer and cementitious networks in said composite material upon reaction of said filler with said fluid.

2. The composite material as claimed in claim 1 wherein:
said particulate filler is a member selected from the group consisting of silicate cements and gypsum.

3. The composite material of claim 2 wherein:
said particulate filler includes at least one of Portland cement and calcium sulphate hemi-hydrate.

4. The composite material of claim 3 wherein said particulate filler further includes a non-reactive component.

5. The composite material of claim 4 wherein said non-reactive component is wood sawdust.

6. The composite material of claim 1 wherein the drawing process is a die drawing process.

7. The composite material of claim 1 wherein the drawing process is a free drawing process.

8. The composite material of claim 3 wherein the weight ratio of Portland cement to oriented polymer is between 37.5 wt. % and 67.5 wt. %.

9. The composite material of claim 3 wherein the weight ratio of Portland cement to oriented polymer is 67.5 wt. %.
